(19) United States
(12) Patent Application Publication
(10) Pub. No.: US 2006/0072935 A1
(43) Pub. Date: Apr. 6, 2006

(54) Adhering pattern and removable protective barrier for a modular printing component

(76) Inventors: Scott K. Hymas, Meridian, ID (US); Harold M. Miller, Nampa, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/013,614

(22) Filed: Dec. 15, 2004

Related U.S. Application Data
(60) Provisional application No. 60/616,775, filed on Oct. 6, 2004.

(51) Int. Cl. G03G 15/08

(52) U.S. Cl. 399/106

(57) ABSTRACT

In one embodiment, an adhesive pattern comprises a length of releasable adhesive defining an elongated generally rectangular perimeter having tapered ends. In another embodiment, an adhesive pattern comprises an endless loop of releasable adhesive defining an elongated generally rectangular perimeter having tapered ends.

### CLAIM OF PRIORITY

This application claims the benefit of U.S. Provisional Application No. 60/616,775, filed on Oct. 6, 2004, and titled ADHERING PATTERN AND REMOVABLE PROTECTIVE BARRIER FOR A MODULAR PRINTING COMPONENT.

### BACKGROUND

Printers, copiers and facsimile machines use modular print components. For example, many laser printers use a replaceable print cartridge that houses the toner reservoir, the photoconductive drum assembly, and the charge and developer roller assemblies. When the toner is gone, the entire cartridge is replaced. Modular cartridges may also be used for other components of the printing device that are consumed or otherwise replaced over the useful life of the device. Print cartridges for laser printers, also commonly called toner cartridges, typically include a toner reservoir, the photoconductor and the charging and toner delivery assemblies. A removable protective barrier called a toner dam is inserted between the toner reservoir portion of the cartridge and the other print components. The toner dam keeps the toner powder separated from the photoconductor and the charging and toner delivery assemblies during shipping and handling. The toner dam is removed just before the cartridge is installed into the printer.

Conventional toner dams are constructed as a strip of flexible material that extends along the opening to the toner reservoir. An adhesive applied to one side of the strip holds the dam in place against the cartridge housing and seals the toner reservoir until the dam is removed. As shown in FIG. 1, a rectangular pattern of adhesive 10 on strip 12 is used for conventional toner dams. The pull force needed to peel a strip 12 with adhesive pattern 10 away from the cartridge housing peaks at the beginning and end of strip 12, as indicated by force spikes 14 and 16 in the pull force profile shown in FIG. 2.

### DRAWINGS

FIG. 1 illustrates an adhesive pattern used on a conventional toner dam.

FIG. 2 illustrates the pull force needed to peel an adhesive pattern used on a conventional toner dam and the pull force needed to peel a new adhesive pattern.

FIG. 3 illustrates a new adhesive pattern whose pull force is illustrated by the solid line in FIG. 2.

FIG. 4 illustrates a toner dam that uses the adhesive pattern shown in FIG. 3.

FIG. 5 illustrates a laser printer cartridge.

FIG. 6 is a detail section view illustrating a toner dam applied to the housing of a print cartridge.

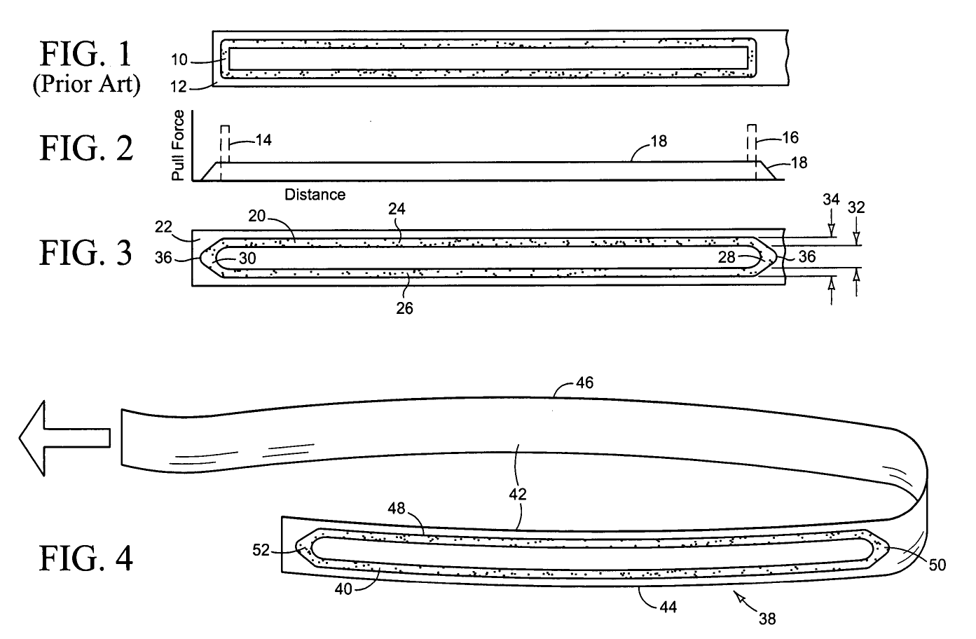

### DESCRIPTION

Embodiments of the present invention were developed in an effort to provide a toner dam that requires less pull force to remove while still sealing the toner reservoir until the dam is removed. Some embodiments of the invention, therefore, will be described with reference to laser printing and removable protective barriers such as toner dams used on laser printer toner cartridges. Embodiments of the invention, however, are not limited to use in laser printing or toner dams. Rather, embodiments of the invention may be used in any application or environment which might benefit from a lower pull force releasable adhesive pattern. The exemplary embodiments shown in the figures and described below illustrate but do not limit the invention. Other forms, details, and embodiments may be made and implemented. Hence, the following description should not be construed to limit the scope of the invention, which is defined in the claims that follow the description.

FIG. 3 illustrates a releasable adhesive pattern whose pull force is illustrated by the solid line 18 in FIG. 2. Referring to FIG. 3, a releasable adhesive is applied to a flexible strip 22 in pattern 20. Adhesive pattern 20 consists of a continuous endless loop of releasable adhesive characterized by two substantially parallel strips 24 and 26 joined by ends 28 and 30. Ends 28 and 30 taper down from an outer perimeter of strips 24 and 26 such that a width 32 across pattern 20 at each end 28 and 30 is not greater than a width 34 across pattern 20 along strips 24 and 26. In the embodiment shown in FIG. 3, pattern 20 tapers to a rounded point 36 at each end 28 and 30.

FIG. 4 illustrates a toner dam 38 that uses a releasable adhesive pattern 40 such as the one shown in FIG. 3. Referring to FIG. 4, toner dam 38 is constructed as a flexible strip 42 that includes a first elongated portion 44 and a second elongated portion 46. Adhesive pattern 40 is applied to one side of only first portion 44 of strip 42. As in the embodiment shown in FIG. 3, adhesive pattern 40 is characterized by an elongated generally rectangular continuous perimeter 48 having tapered ends 50 and 52.

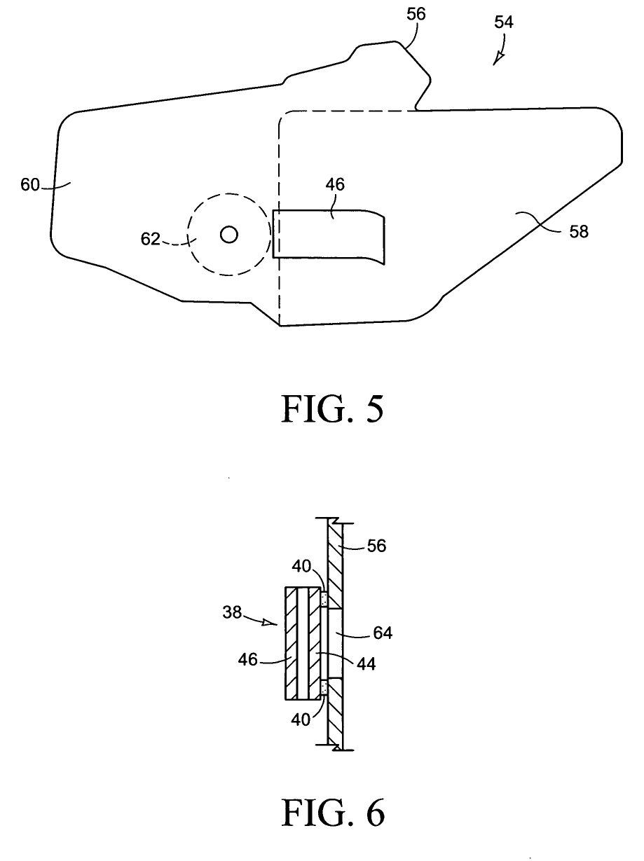

FIG. 5 illustrates a print cartridge 54 such as might be used in a laser printer. FIG. 6 is a detail section illustrating toner dam 38 applied to print cartridge 54. Referring to FIGS. 5 and 6, housing 56 of cartridge 54 is formed generally in two sections—a toner reservoir section 58 and print component section 60. Toner is stored in toner reservoir 58. The photoconductor 62 and the charging assembly (not shown) are mounted in the print component section 60. Depending on the type of print cartridge, the two sections of housing 56 may be formed as an integral unit, or attached to one another as individual sections. In either case, toner dam 38 extends along an opening 64 between toner reservoir 58 and the print component section 60 of housing 56. First strip portion 44 of toner dam 38 covers opening 64 with adhesive pattern 40 sealing opening 64. Second strip portion 46 of dam 38 is doubled back over first portion 44. The free end of second portion 46 of toner dam 38 extends out from cartridge 54. With this configuration, a user can easily grab the end of strip portion 46 directly or by a handle or ring, if one is provided, and pull toner dam 38 out of cartridge 54 to uncover opening 64.

While it is expected that a releasable adhesive in the desired pattern will be used in most applications, other releasable adhering means are possible. For example, a flexible part such as toner dam 38 and a rigid part such as housing 56 may be made to releasably adhere to one another with the desired release characteristics by melting the two parts together along an elongated generally rectangular path having tapered ends. This technique is often referred to as heat staking. For heat staking, the parts are staked in an adhering pattern, such as pattern 20 in FIG. 3, in which the pull force needed to initiate releasing the flexible part from the rigid part is less than the pull force needed to continue release the flexible part from the rigid part.

As noted at the beginning of this Description, the exemplary embodiments shown in the figures and described above illustrate but do not limit the invention. Other forms, details, and embodiments may be made and implemented. Therefore, the foregoing description should not be construed to limit the scope of the invention, which is defined in the following claims.

What is claimed is:

1. An adhesive pattern, comprising a length of releasable adhesive defining an elongated generally rectangular perimeter having tapered ends.

2. The adhesive pattern of claim 1, wherein the length of releasable adhesive comprises a continuous length of adhesive.

3. An adhesive pattern, comprising an endless loop of releasable adhesive defining an elongated generally rectangular perimeter having tapered ends.

4. The adhesive pattern of claim 3, wherein the tapered ends are pointed.

5. An adhesive pattern, comprising a continuous length of releasable adhesive defining two substantially parallel strips joined by ends having an outer perimeter that tapers down from the two strips such that a width across the pattern at each end is not greater than a width across the pattern along the strips.

6. An adhesive strip, comprising a flexible strip and an endless loop of releasable adhesive on one side of the strip, the loop of releasable adhesive configured such that the pull force needed to initiate releasing the strip from a surface to which it adheres is less than the pull force needed to continue releasing the strip from the surface.

7. An adhesive strip, comprising a flexible strip and a length of releasable adhesive on one side of the strip, the length of releasable adhesive defining an elongated generally rectangular perimeter having tapered ends.

8. The adhesive pattern of claim 7, wherein the length of releasable adhesive comprises a continuous length of releasable adhesive.

9. An adhesive strip, comprising a flexible strip and an endless loop of releasable adhesive on one side of the strip, the loop of releasable adhesive defining an elongated generally rectangular perimeter having tapered ends.

10. An article, comprising a flexible part adhering to a rigid part along an elongated generally rectangular path having tapered ends.

11. The article of claim 10, further comprising an endless loop of releasable adhesive defining the elongated generally rectangular path with tapered ends.

12. An article, comprising a flexible part adhering to a rigid part along two substantially parallel strips joined by ends having an outer perimeter that tapers down from the two strips such that a width across the pattern at each end is not greater than a width across the pattern along the strips.

13. An article, comprising:
a rigid part;
a flexible part;
a means for the flexible part releasably adhering to the rigid part such that the pull force needed to initiate releasing the flexible part from the rigid part is less than the pull force needed to continue release the flexible part from the rigid part.

14. A removable protective barrier for a modular printing component, comprising:
a flexible strip having a first elongated portion and a second elongated portion longer than the first elongated portion; and
an endless loop of releasable adhesive on one side of only the first elongated portion of the strip, the loop of releasable adhesive defining an elongated generally rectangular perimeter having tapered ends.

15. A removable protective barrier for a modular printing component, comprising:
a flexible strip having a first elongated portion and a second elongated portion longer than the first elongated portion; and
an endless loop of releasable adhesive on one side of only the first elongated portion of the strip, the loop of releasable adhesive configured such that the pull force needed to initiate releasing the strip from a surface to which it adheres is less than the pull force needed to continue releasing the strip from the surface.

16. A print cartridge, comprising:
a housing having an interior chamber containing a media marking material and an opening therein to the interior chamber; and
a removable protective barrier covering the opening in the housing, the barrier comprising a flexible strip having a first elongated portion adhering to the housing along an elongated generally rectangular path having tapered ends that surrounds the opening and a second elongated portion longer than the first elongated portion.

17. The cartridge of claim 16, further comprising an endless loop of releasable adhesive defining the elongated generally rectangular path with tapered ends.

18. A print cartridge, comprising:
a housing having an interior chamber containing a marking material and an opening therein to the interior chamber; and
a removable protective barrier covering the opening in the housing, the barrier comprising a flexible strip having a first elongated portion and a second elongated portion longer than the first elongated portion and an endless loop of releasable adhesive on one side of only the first elongated portion of the strip, the loop of releasable adhesive configured such that the pull force needed to initiate releasing the strip from a surface to which it adheres is less than the pull force needed to continue releasing the strip from the surface.
